(19) United States
(12) Patent Application Publication
(10) Pub. No.: US 2008/0019766 A1
(43) Pub. Date: Jan. 24, 2008

(54) Ball joint assembly

(75) Inventors: Rick Flaim, New Boston, MI (US); Troy Foster, Troy, MI (US)

Correspondence Address: CLARK HILL, P.C., 500 WOODWARD AVENUE, SUITE 3500, DETROIT, MI, 48226, US

(73) Assignee: Rayco Manufacturing, Inc., Sterling Heights, MI (US)

(21) Appl. No.: 11/492,137

(22) Filed: Jul. 24, 2006

(51) Int. Cl. F16C 11/00

(52) U.S. Cl. 403/122

(57) ABSTRACT

A ball joint assembly includes a housing that defines a longitudinal axis and a channel extending therethrough. The housing also includes a socket which is coaxial with the longitudinal axis and is in fluid communication with the channel. The socket defines a socket radius. The ball joint assembly includes a ball that is receivable by the socket. The ball defines a ball channel extending therethrough. The ball joint assembly includes a plate that is fixedly secured to the housing to secure the ball and the channel. A plurality of seals extend about the ball preventing air from passing through the channel around the ball. Plates having rims of different thicknesses will provide different levels of tightness between the ball and the socket to vary the amount of freedom of movement the ball has with respect to the housing.

### BACKGROUND ART

1. Field of the Invention

The invention relates to fixtures used in the manufacture of products. More particularly, the invention relates to fixtures that are capable of facilitating or transmitting a force therethrough to aid in the assembly and manufacture of products.

2. Description of the Related Art

Manufacturers of products are incorporating robotics and robot-assist mechanisms into their assembly to maximize efficiencies relates to the production of the products they sell. It is quite common for a part to be held by one or more suction cups as it is being moved from one place to another during the assembly of a product because of the part's size and finish. More specifically, a suction cup is able to provide a retaining force allowing a robot arm to lift a part without having to squeeze it or crimp it with robot fingers. Maintaining a vacuum in the suction cup is very important. This important feature limits the ability of the fixtures currently including suction cups from operating in an optimal position or with optimal flexibility.

U.S. Pat. No. 5,845,950 discloses a pneumatically actuated magnetic article holder. This device requires the use of a pneumatic actuator and a permanent magnetic. This device is cumbersome and has limited applicability due to the fact that it requires a magnet to operate. Non-metallic parts will not be able to be maneuvered or manipulated using this device.

### SUMMARY OF THE INVENTION

A ball joint assembly includes a housing that defines a longitudinal axis and a channel extending therethrough. The housing also includes a socket which is coaxial with the longitudinal axis and is in fluid communication with the channel. The socket defines a socket radius. The ball joint assembly includes a ball that is receivable by the socket. The ball defines a ball channel extending therethrough. The ball joint assembly includes a plate that is fixedly secured to the housing to secure the ball and the channel. A plurality of seals extend about the ball preventing air from passing through the channel around the ball.

### BRIEF DESCRIPTION OF THE DRAWINGS

Advantages of the invention will be readily appreciated as the same becomes better understood by reference to the following detailed description when considered in connection with the accompanying drawings, wherein:

FIG. 1 is a perspective view of one embodiment of the invention shown in operation;

FIG. 2 is a perspective view of the invention;

FIG. 3 is a cross-sectional side view of one embodiment of the invention;

FIG. 4 is an exploded perspective view of the invention; and

FIG. 5 is a cross-sectional side view of an alternative embodiment of the invention with the ball pivoted within the socket.

### DETAILED DESCRIPTION OF THE PREFERRED EMBODIMENTS

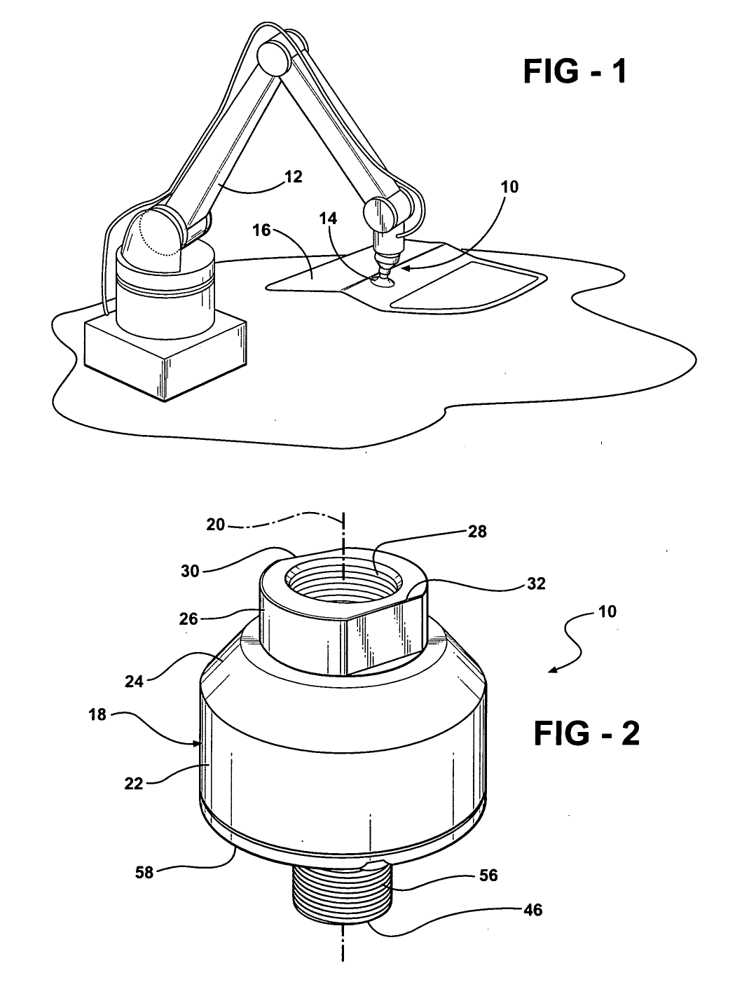

Referring to FIG. 1, one embodiment of the invention, a ball joint assembly is generally indicated at 10. The ball joint assembly 10 is fixedly secured to an automation device 12. As is represented in FIG. 1, the automation device 12 is a robot arm. It should be appreciated by those skilled in the art that the ball joint assembly 10 may be secured to any type of structure that is capable of moving in some fashion. A suction cup 14 is fixedly secured to the ball joint assembly 10 at an end opposite that which the automation device 12 is secured. The suction cup 14 is used to grip a part 16 that is required for a manufacture or assembly process. Operation of the suction cup will be discussed in greater detail subsequently.

Referring to FIG. 2, the ball joint assembly 10 includes a housing, generally shown at 18. The housing 18 defines a longitudinal axis 20. The housing 18 defines an outer cylindrical surface 22 and a chamfered surface 24 disposed adjacent the outer cylindrical surface 22. A housing neck 26 extends out from the chamfered surface 24. The housing neck 26 includes an interiorly threaded hole 28 designed to be received by the automation device 12. More specifically, the interiorly threaded hole 28 of the housing neck 26 is threadedly engaged with the automation device 12. Two wrench flats 30, 32 allow the housing neck 26 to receive a wrench (not shown) to facilitate the tightening of the housing neck 26 over a portion of the automation device 12.

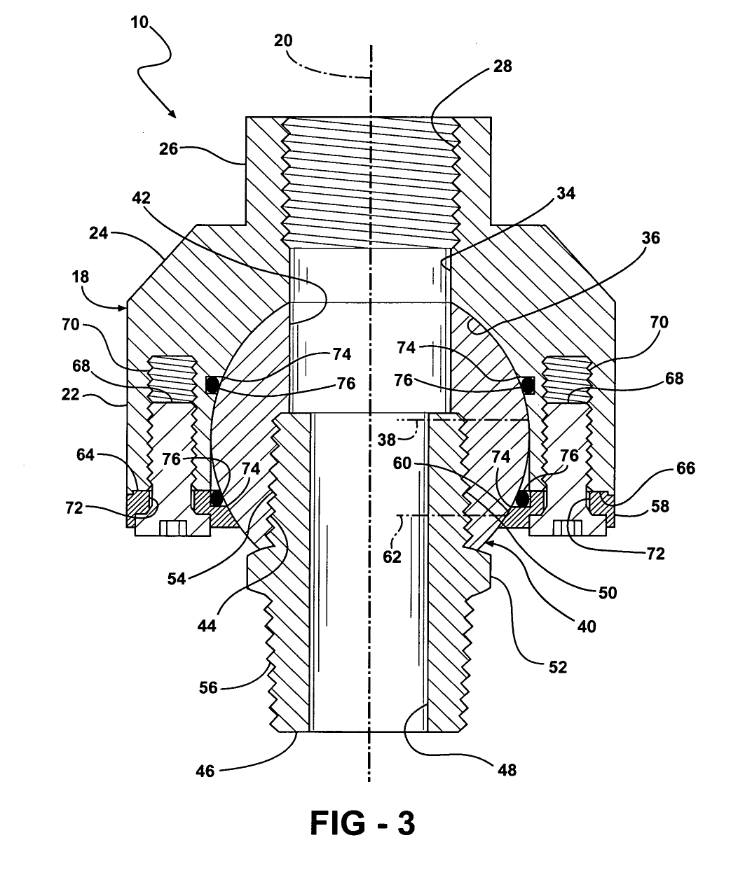

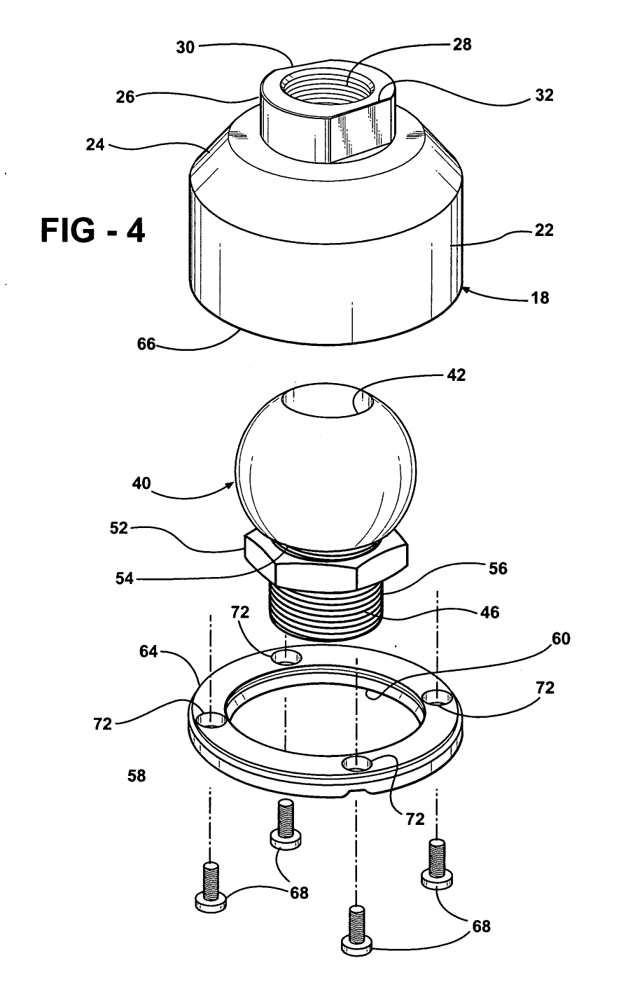

Referring to FIG. 3, the housing 18 also includes a channel 34 which extends through the housing 18. The channel 34 is in fluid communication with the interiorly threaded hole 28 in that the channel 34 is in fluid communication therewith. In the embodiment shown in FIG. 3, the interiorly threaded hole 28 and the channel 34 have an identical diameter, such that the interiorly threaded hole 28 is merely a threaded portion of the channel 34.

The housing 18 also includes a socket 36. The socket 36 is coaxial with the longitudinal axis 20 and, hence, the channel 34. The socket 36 defines a socket radius 38. As such, much of the socket 36 is spherical in shape.

The ball joint assembly 10 further includes a ball, generally shown at 40. The ball 40 is received by the socket 36 having a radius equal to or less than the socket radius 38. The ball 40 defines a ball channel 42. The ball channel 42 extends through the entire ball 40. The ball 40 is positioned within the socket 36 such that the ball channel 42 is generally coaxial with the longitudinal axis 20. The ball channel 42 is in fluid communication with the channel 34 of the housing 18. A portion 44 of the ball channel 42 is threaded. The threaded portion 44 receives a ball neck 46 therein. The ball neck 46 includes a ball neck channel 48, which is in fluid communication with the ball channel 42 and the channel 34 of the housing 18. Therefore, the channels 34, 42, 48 of the ball joint assembly 10 create a path through which a fluid may pass. In the preferred embodiment, the fluid that is passing therethrough is a gas, such as air. When the automation device 12 activates a vacuum, air is drawn through the channels 34, 42, 48 and operate the suction cup 14 disposed at the end of the ball neck channel 48.

The ball neck 46 includes an exteriorly threaded cylindrical surface 50 that is divided into by a tool engaging surface 52. A top half 54 of the exteriorly threaded surface 50 is received by the threaded portion 44 of the ball channel. A bottom half 56 of the exteriorly threaded surface 50 receives the suction cup 14 allowing the suction cup 14 to be secured thereto.

A plate 58 is fixedly securable to the housing 18. The plate 58 secures the ball 40 within the socket 36. The plate 58 defines a plate aperture 60 that allows a portion of the ball 40 extend therethrough. The plate aperture 60 defines a aperture radius 62 which is less than the socket radius 38. The plate 58 also includes a rim 64 that circumscribes the plate 58. Referring to FIG. 3, the rim 64 is of a predetermined thickness that, when fully engaged with a bottom surface 66 of the housing 18, the ball 40 cannot be moved with respect to the socket 36. The rim 64 defines a thickness that prevents the ball 40 from moving relative to the housing 18 when the plate 58 is tightened against the bottom surface 66 of the housing 18. The plate 58 is secured to the housing 18 with a plurality of fasteners 68. In the embodiment shown, the fasteners 68 are screws 68 that are received by a plurality of threaded holes 70 inside the housing 18. The plate 58 includes a plurality of fastener holes 72 that extend therethrough to facilitate each fastener 68 extending therethrough and being received by each of the plurality of threaded holes 70 inside the housing 18. The fastener holes 72 and the plurality of threaded holes 70 are parallel to the longitudinal axis 20.

The housing 18 also includes a plurality of seal seats 74 which are disposed about the socket 36. A plurality of seals 76 are held in place at the plurality of seal seats 74. The plurality of seals 76 prevent fluid from passing through the socket 36 about the outside of the ball 40. In the preferred embodiment, the plurality of seals 76 include two O-rings.

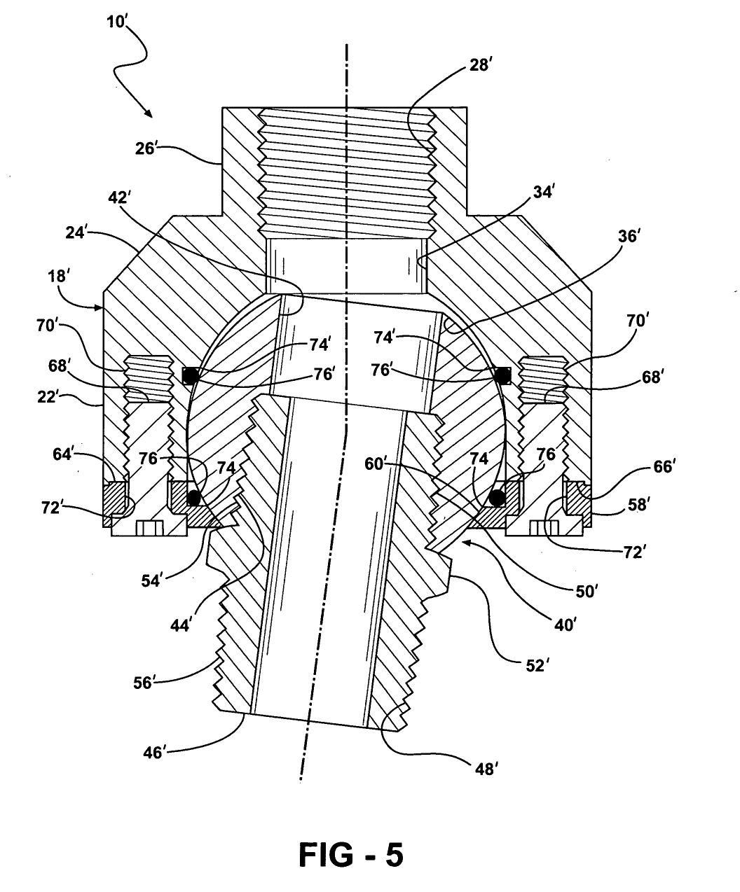

Referring to FIG. 5, wherein like prime numerals represent similar structures to those found in the preferred embodiment, an alternative embodiment of the ball joint assembly is generally indicated at 10′. In this alternative embodiment, the ball joint assembly 10′ is virtually identical to that of the preferred embodiment. Therefore, may of the elements will not be described in this portion of the specification as they are identical to that which is discussed above. The difference between the preferred embodiment and the alternative embodiment is the thickness of the rim 64′ of the plate 58′. The thickness of the rim 64′ is thicker than that of the rim 64 in the first embodiment. By increasing the thickness of the rim 64′, the plate aperture 60′ is lowered with respect to the bottom 66′ of the housing 18′. By lowering the plate aperture 60′, the ball 40′ is lowered from the socket 36′ a predetermined amount directly related to the additional thickness of the rim 64′. With less of the ball 40′ engaging the socket 36′, the ball 40 has the ability to moved with respect to the housing 18′. Therefore, the ball 40′ and the ball neck 46′ may be pivoted with respect to the housing 18′ should such movement be desired. This will allow for more ergonomic operation of the ball joint assembly 10′ and the automation device 12 should this freedom of movement be needed.

In operation, the ball joint assembly 10 is secured to the automation device 12 by screwing the ball joint assembly 10 onto the automation device 12. The suction cup 14 is threaded about the bottom half 56 of the exteriorly threaded surface 50′ when it is desired to have the suction cup lift apart, a vacuum is drawn through the automation device 12. The vacuum will then pull fluid from the channels 34, 42, 48 to force the suction cup 14 to secure itself to the part 16. Once engaged, the automation device 12 may move the part 16 to the proper place. Upon reaching the proper position and/or orientation of the part 16, the automation device 12 will release the vacuum and allow fluid to flow through the ball joint assembly 10 through its channels 34, 42, 48 and, hence, release the suction cup 14 allowing the part 16 to be freed of the automation device 12.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

We claim:

1. A ball joint assembly comprising:
a housing defining a longitudinal axis, a channel therethrough along said longitudinal axis and a socket coaxial with said longitudinal axis in fluid communication with said channel, said socket defining a socket radius;
a ball receivable by said socket, said ball defining a ball channel extending therethrough;
a plate fixedly securable to said housing to secure said ball in said socket; and
a plurality of seals about said ball preventing air from passing through said channel around said ball.

2. A ball joint assembly as set forth in claim 1 wherein said plate includes a plate aperture allowing a portion of said ball to extend therethrough.

3. A ball joint assembly as set forth in claim 2 wherein said plate aperture defines an aperture radius smaller than said socket radius.

4. A ball joint assembly as set forth in claim 3 wherein said plate includes a rim circumscribing said plate.

5. A ball joint assembly as set forth in claim 4 wherein said rim defines a thickness preventing said ball from moving relative to said housing when said plate is tightened against said housing.

6. A ball joint assembly as set forth in claim 4 wherein said rim defines a thickness allowing said ball to move relative to said housing when said plate is tightened against said housing.

7. A ball joint assembly as set forth in either of claims 5 or 6 wherein said housing includes a plurality of seats to hold each of said plurality in place to seal said ball with said housing.

8. A ball joint assembly as set forth in claim 7 wherein said housing includes a plurality of threaded holes extending through a portion of said housing parallel to said longitudinal axis.

9. A ball joint assembly as set forth in claim 8 wherein said ball includes a ball neck extending out therefrom coaxial with said ball channel.

10. A ball joint assembly as set forth in claim 9 wherein said ball neck includes a threaded exterior surface.

11. A ball joint assembly comprising:
a housing defining a longitudinal axis, a channel therethrough along said longitudinal axis and a socket coaxial with said longitudinal axis in fluid communication with said channel, said socket defining a socket radius;
a ball receivable by said socket, said ball defining a ball channel extending therethrough;
a plate fixedly securable to said housing to secure said ball in said socket, said plate including a rim circumscribing said plate, said rim defining a thickness preventing said ball from moving relative to said housing when said plate is tightened against said housing; and
a plurality of seals about said ball preventing air from passing through said channel around said ball.

12. A ball joint assembly as set forth in claim 11 wherein said plate includes a plate aperture allowing a portion of said ball to extend therethrough.

13. A ball joint assembly as set forth in either of claim 12 wherein said housing includes a plurality of seats to hold each of said plurality in place to seal said ball with said housing.

14. A ball joint assembly as set forth in claim 13 wherein said housing includes a plurality of threaded holes extending through a portion of said housing parallel to said longitudinal axis.

15. A ball joint assembly as set forth in claim 14 wherein said ball includes a ball neck extending out therefrom coaxial with said ball channel.

16. A ball joint assembly comprising:
a housing defining a longitudinal axis, a channel therethrough along said longitudinal axis and a socket coaxial with said longitudinal axis in fluid communication with said channel, said socket defining a socket radius;
a ball receivable by said socket, said ball defining a ball channel extending therethrough;
a plate fixedly securable to said housing to secure said ball in said socket, said plate defining a rim; and
a plurality of seals about said ball preventing air from passing through said channel around said ball.

17. A ball joint assembly as set forth in claim 16 wherein said rim defines a thickness allowing said ball to move relative to said housing when said plate is tightened against said housing.

18. A ball joint assembly as set forth in claim 17 wherein said plate includes a plate aperture allowing a portion of said ball to extend therethrough.

19. A ball joint assembly as set forth in claim 18 wherein said plate aperture defines an aperture radius smaller than said socket radius.

20. A ball joint assembly as set forth in claim 19 wherein said plate includes a rim circumscribing said plate.
